(19) United States
(12) Patent Application Publication
(10) Pub. No.: US 2019/0258984 A1
(43) Pub. Date: Aug. 22, 2019

(54) GENERATIVE ADVERSARIAL NETWORKS IN PREDICTING SEQUENTIAL DATA

(71) Applicant: Microsoft Technology Licensing, LLC, Redmond, WA (US)

(72) Inventors: Muhammad Ebadur Rehman, Waterloo (CA); Huiji Gao, Sunnyvale, CA (US); Jun Jia, Sunnyvale, CA (US); Bo Long, Palo Alto, CA (US)

(21) Appl. No.: 15/898,847

(22) Filed: Feb. 19, 2018

(51) Int. Cl. G06Q 10/06; G06N 3/04; G06F 17/30; G06N 3/08; G06F 15/18

(52) U.S. Cl. CPC G06Q 10/063112; G06N 3/0454; G06Q 10/1053; G06N 3/088; G06F 15/18; G06F 17/30867

(57) ABSTRACT

Techniques for predicting sequential data using generative adversarial networks are disclosed herein. In some embodiments, a method comprises: receiving a request associated with a user of an online service; in response to the receiving of the request, retrieving a first plurality of sequential data points of the user from a profile of the user stored on a database of the online service, the first plurality of sequential data points comprising at least one attribute for each one of a plurality of sequential career points of the user; generating at least one predicted data point for the user based on the first plurality of sequential data points using a generative model, the generated at least one predicted data point comprising at least one attribute for a predicted career point for the user; and performing a function of the online service using the generated at least one predicted data point.

### TECHNICAL FIELD

The present application relates generally to generative adversarial networks and, in one specific example, to methods and systems of predicting sequential data using a generative adversarial network.

### BACKGROUND

Prediction models may be used by online services to predict one or more data points based on a sequence of data points. However, such prediction models suffer from a lack of accuracy and relevancy. This lack of accurate and relevant data can cause technical problems in the performance of the online service. As a result of the lack of accuracy and relevancy, users often spend a longer time using certain functions of the online service, thereby consuming electronic resources (e.g., network bandwidth, computational expense of performing functions). Additionally, current techniques rely on a loss function for training prediction models. However, this reliance on the loss function is not effective in guiding a prediction model with respect to generating sequential data. Current maximum likelihood methods are not successful at capturing the probability distribution of the underlying data and, therefore, are incapable of generating meaningful or quality predictions.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating components of a data prediction system, in accordance with an example embodiment.

FIG. 4 is a block diagram illustrating a generator, in accordance with an example embodiment.

FIG. 5 illustrates a graphical user interface (GUI) in which generated predicted data points are used in a function of an online service, in accordance with an example embodiment.

FIG. 6 illustrates another GUI in which generated predicted data points are used in a function of an online service, in accordance with an example embodiment.

FIG. 7 illustrates yet another GUI in which generated predicted data points are used in a function of an online service, in accordance with an example embodiment.

FIG. 8 illustrates yet another GUI in which generated predicted data points are used in a function of an online service, in accordance with an example embodiment.

FIG. 9 illustrates yet another GUI in which generated predicted data points are used in a function of an online service, in accordance with an example embodiment.

FIG. 10 is a flowchart illustrating a method of predicting sequential data using a generative adversarial network, in accordance with an example embodiment.

FIG. 11 is a block diagram illustrating a mobile device, in accordance with some example embodiments.

FIG. 12 is a block diagram of an example computer system on which methodologies described herein may be executed, in accordance with an example embodiment.

### DETAILED DESCRIPTION

Example methods and systems of predicting sequential data using generative adversarial networks are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein. Some technical effects of the system and method of the present disclosure are to reduce the consumption of electronic resources of an online service by improving the accuracy and relevancy of generative models, as well as to address the particular problems generative models encounter in generating sequential data. Additionally, other technical effects will be apparent from this disclosure as well. Although some example embodiments disclosed herein involve use cases for generating future career points for a user based on a historical sequence of career points for the user, it is contemplated that the features disclosed herein may be used with other types of data as well.

In some example embodiments, operations are performed by a computer system for other machine) having a memory and at least one hardware processor, with the operations comprising, receiving a request associated with a user of an online service; in response to the receiving of the request, retrieving a first plurality of sequential data points of the user from a profile of the user stored on a database of the online service, the first plurality of sequential data points comprising at least one attribute for each one of a plurality of sequential career points of the user; generating at least one predicted data point for the user based on the first plurality of sequential data points using a generative model, the generated at least one predicted data point comprising at least one attribute for a predicted career point for the user; and performing a function of the online service using the generated at least one predicted data point.

In some example embodiments, the operations further comprise training the generative model using a generative adversarial network (GAN), the GAN comprising a generative neural network and a discriminative neural network, the GAN configured to generate candidate sequential data points based on source sequential data points retrieved from profiles stored on the database of the online service, the discriminative neural network comprising a two-class classification convolutional neural network (CNN) configured to discriminate between the generated candidate sequential data points and hue sequential data points retrieved from the profiles stored on the database of the online service.

In some example embodiments, the training comprises using reinforcement learning to train the generative model, the discriminative neural network being further configured to issue a reward to the GAN based on a determination that the GAN fooled the discriminative neural network into identifying the candidate sequential data points as being true sequential data points retrieved from the profiles stored on the database of the online service.

In some example embodiments, the GAN is configured to generate the candidate sequential data points based on the source sequential data points using a Monte Carlo sampling method.

In some example embodiments, attribute(s) for each one of the plurality of sequential career points comprises at least one company name, and the attribute(s) for the predicted career point comprises at least one other company name.

In some example embodiments, the at least one attribute for each one of the plurality of sequential career points comprises at least one company name and one or more of a job title, a company size, and an industry, and the at least one attribute for the predicted career point comprises at least one other company name and one or more of another job title, another company size, and another industry.

In some example embodiments, the generated at least one predicted data point comprises a sequence of predicted data points, each predicted data point in the sequence comprising the at least one attribute for the corresponding predicted career point.

In some example embodiments, the performing the function comprises causing the generated predicted career point(s) to be displayed on a computing device in association with the request.

In some example embodiments, the request comprises a search query submitted to a search engine of the online service, and the performing the function comprises using the generated at least one predicted career point in a query expansion operation for the search query to expand the search query to include the generated at least one predicted career point.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

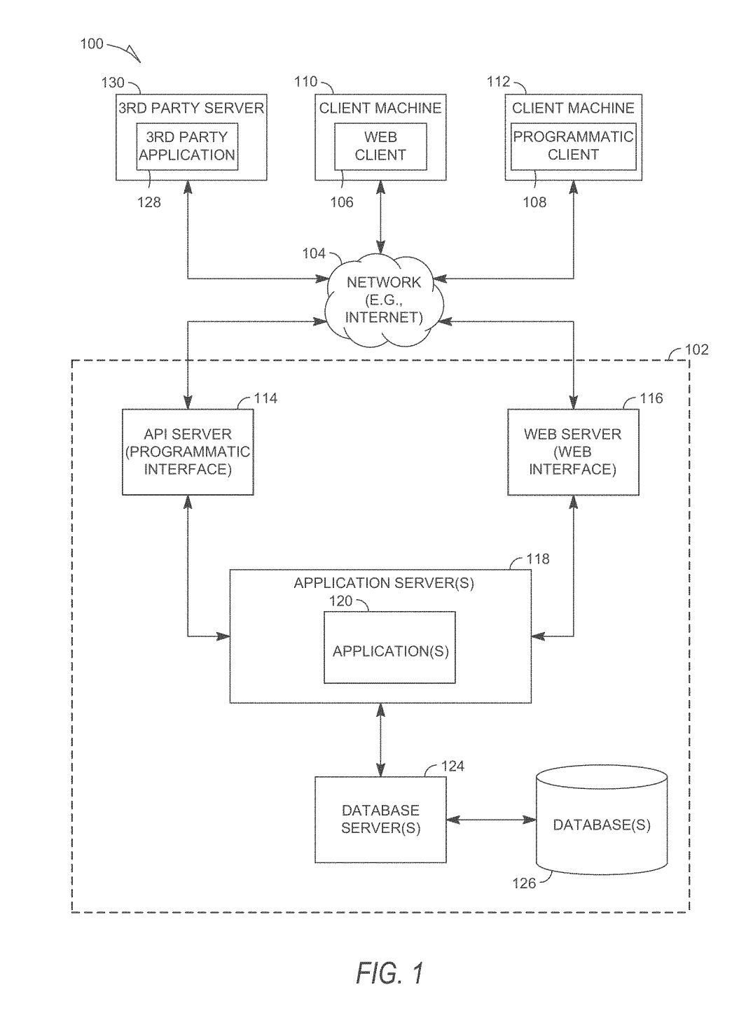

FIG. 1 is a block diagram illustrating a client-server system 100, in accordance with an example embodiment. A networked system 102 provides server-side functionality via a network 104 (e.g., the Internet or Wide Area Network (WAN)) to one or more clients FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

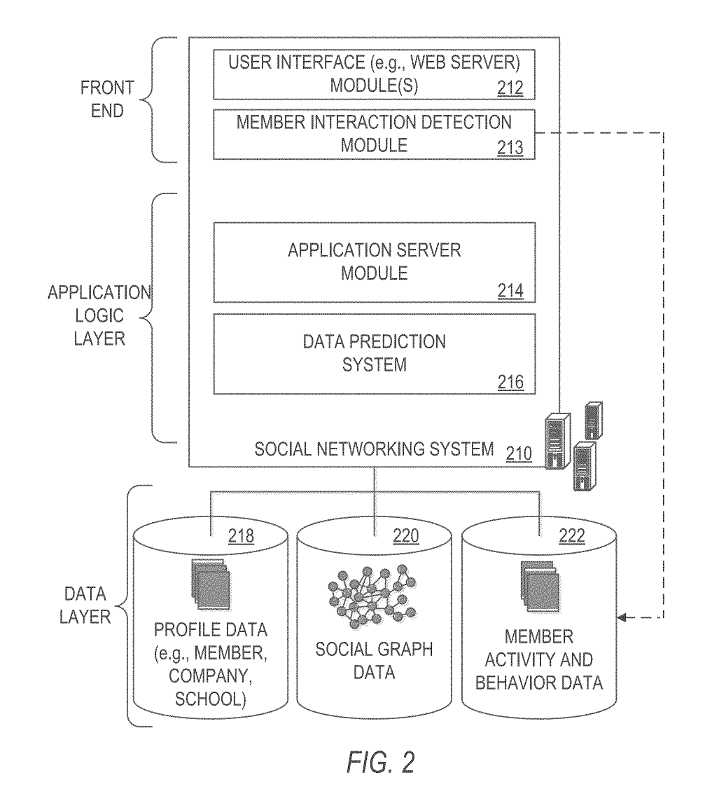

In some embodiments, the networked system 102 may comprise functional components of a social networking service. FIG. 2 is a block diagram showing the functional components of a social networking system 210, including a data processing module referred to herein as a data prediction system 216, for use in social networking system 210, consistent with some embodiments of the present disclosure. In some embodiments, the data prediction system 216 resides on application served s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service In some example embodiments, the application logic layer includes the data prediction system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the data prediction system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

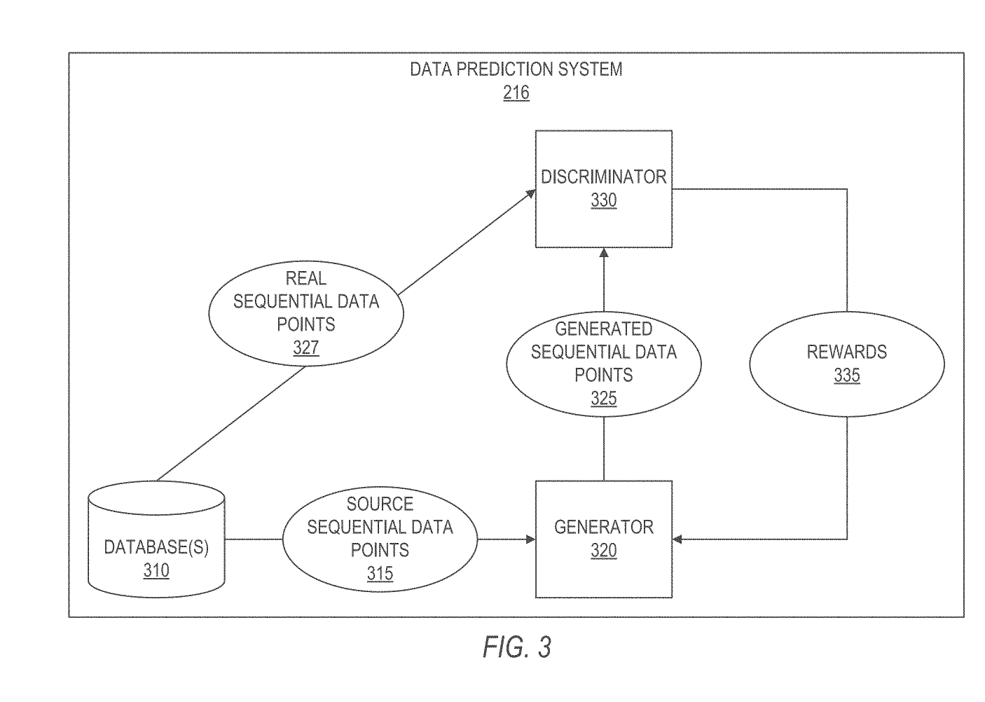

FIG. 3 is a block diagram illustrating components of the data prediction system 216, in accordance with an example embodiment. The data prediction system 216 may generate sequential data points based on source sequential data points using a generative model. For example, in some example embodiments, the data prediction system 216 is configured to generate a sequence of career points forming a career path for a user (e.g., a member) of an online service (e.g., social networking service 210 of FIG. 2) based on the user's career history data using the generative model. The data prediction system 216 may also be configured to train the generative model using a GAN.

In some embodiments, the data prediction system 216 comprises one or more databases 310, a generator 320, and a discriminator 330. The database(s) 310, generator 320, and discriminator 330 can reside on a computer system, or other machine, having a memory and at least one processor (not shown). In some embodiments, the database(s) 310, generator 320, and discriminator 330 can be incorporated into the application served s) 118 in FIG. 1. In some example embodiments, the database(s) 310 is incorporated into database(s) 126 in FIG. 1 and can include any combination of one or more of databases 218, 220, and 222 in FIG. 2. However, it is contemplated that other configurations of the database(s) 310, generator 320, and discriminator 330, are also within the scope of the present disclosure.

In some example embodiments, the generator 320 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screens, camera, tactile sensors, light sensors, infrared sensors, biometric sensors, microphone, gyroscope, accelerometer, other sensors, and so forth). In some example embodiments, the generator 320 is configured to receive user input. For example, the generator 320 can present one or more GUI elements (e.g., drop-down menu, selectable buttons, text field) with which a user can submit input.

In some example embodiments, the generator 320 and the discriminator 330 are configured to perform various communication functions to facilitate the functionality described herein, such as by communicating with the social networking system 210 via the network 104 using a wired or wireless connection. Generator 320 and discriminator 330 may also provide various web services or functions, such as retrieving information from the third patty servers 130 and the social networking system 210. Information retrieved by either or both of the generator 320 and the discriminator 330 may include profile data corresponding to users and members of the social networking service of the social networking system 210.

Additionally, the generator 320 and the discriminator 330 can provide various data functionality, such as exchanging information with the database(s) 310. For example, the generator 320 and the discriminator 330 can access member profiles that include profile data from the database(s) 310, as well as extract attributes and/or characteristics from the profile data of member profiles. Furthermore, the generator 320 and the discriminator 330 can access profile data, social graph data, and member activity and behavior data from the database(s), as well as exchange information with third party servers 130, client machines 110, 112, and other sources of information.

In some example embodiments, the generator 320 comprises a generative neural network configured to train a generative model using a generative adversarial network (GAN). A GAN is a deep neural network architecture that employs a class of artificial intelligence algorithms used in machine learning, implemented by a system of two neural networks contesting each other in an adversarial zero-sum game framework. In some example embodiments, the GAN comprises a generative neural network, such as the generator 320, configured to generate candidates and a discriminative neural network, such as the discriminator 330, configured to evaluate the generated candidates. The generator 320 learns to map from a latent space to a particular data distribution of interest, while the discriminator 330 discriminates between instances from the true data distribution and candidates produced by the generator 320. The objective of training the generator 320 is to increase the error rate of the discriminator 310 (e.g., to “fool” the discriminator 310 by producing novel synthesized instances that appear to have come from the true data distribution).

In some example embodiments, the generator 320 is configured to generate candidate sequential data points 325 based on source sequential data points 315 retrieved from profiles stored on the database(s) 310 of an online service. In some example embodiments, each generated candidate sequential data point 325 comprises a career point. A career point comprises any combination of one or more attributes of a user's employment at a particular point in time. The source sequential data points 315 may comprise attributes stored as part of a profile of a user. Such attributes may include, but are not limited to, any combination of one or more of a company or organization with which the user was previously or is currently employed (e.g., “Acme Inc.”), a job title of the user with a company or organization with which the user was previously or is currently employed (e.g., “Software Engineer”), a size of a company or organization with which the user was previously or is currently employed (e.g., “10,000+ employees”), skills of the user (e.g., “Machine Learning”), education of the user (e.g., university attended, courses, major), and an industry of a company or organization with which the user was previously or is currently employed (e.g., “Computer Software”).

In some example embodiments, the generator 320 comprises a sequence-to-sequence model that inputs a sequence of career history data of a user, and then generates and outputs a predicted career path in the form of a sequence of predicted career points. In one example, the source sequential data points 315 may comprise the following career points of the user: (1) employment at company C1, (2) followed by employment at company C2, (3) followed by employment at company C3, and (4) followed by employment at company C4 The generator 320 may take these four source sequential data points 315 as input and apply them to the generative model in generating sequential data points 325, which may include the following career points for this example: (1) employment at company C5 to follow employment at company C4, (2) followed by employment at company C6, and (3) followed by employment at company C7. In this example, the combination of the source sequential data points 315 and the generated sequential data points 325 results in the predicted career path C5 to C6 to C7 to follow the existing career path C1 to C2 to C3 to C4 for the user.

In some example embodiments, the discriminator 330 comprises a two-class classification convolutional neural network (CNN) configured to discriminate between the generated candidate sequential data points 325 and real or true sequential data points 327 retrieved from the profiles stored on the database(s) 310 of the online service. The discriminator 330 may use a discriminative model to discriminate between the different types of sequential data points 325 and 327. A discriminative model is a class of models used in machine learning for modelling the dependence of unobserved (target) variables on observed variables. Within a probabilistic framework, this modelling is achieved by modelling the conditional probability distribution, which can be used for predicting the unobserved (target) variables from the observed variables.

The generator 320 may transmit the generated sequential data points 325 to the discriminator 330 along with the corresponding source sequential data points 315 and a flag or other label indicating that the generated candidate sequential data points 325 were generated by the generator 320. Additionally, the discriminator 330 may also retrieve, or otherwise receive, the real sequential data points 327 from the database(s) 310 of the online service along with the corresponding source sequential data points 315 and a flag or other label indicating that the real sequential data points 327 are the real or true data points. In some example embodiments, for every set of generated candidate sequential data points 325 and every set of real sequential data points 327 received by the discriminator 330, the discriminator 330 determines whether that set of sequential data points is either machine-generated by the generator 320 or is sourced from the real data distribution (e.g., from a profile stored in the database(s) 310). The discriminator 330 uses the corresponding flag or label of that set of sequential data points to determine whether it correctly classified the set of sequential data points. This evaluation of the performance of the discriminator for each set of sequential data points is then used to train the generator 320.

In some example embodiments, the training of the generator 320 comprises using reinforcement learning to train the generative model. Reinforcement learning is a type of dynamic programming that trains algorithms using a system of reward and punishment. A reinforcement learning algorithm, or agent, learns by interacting with its environment. The agent receives rewards by performing correctly and penalties for performing incorrectly. The agent learns without intervention from a human by maximizing its reward and minimizing its penalty. In some example embodiments, the discriminator 330 is configured to issue a reward 335 to the generator 320 based on a determination that the generator 320 fooled the discriminator 330 into identifying the generated sequential data points 325 as being real or true sequential data points 327 retrieved from the profiles stored on the database(s) 310 of the online service.

GANs work well with continuous data, such as images where the distribution can be modelled as continuous from pixel to pixel. However, a technical problem arises when dealing with use cases that involve discrete sequential data points or tokens, such as career points. For example, in a scenario where the generator 320 outputs two tokens, company C1 and company C2. Although these two tokens may be very similar in their corresponding attributes, such as industry, size, and job title, typical GAN models interpret them as different entities, and so the difference that such GAN models attributes to them (the loss function) does not have much meaning to them.

In order to mitigate this technical problem of the loss function not being meaningful in use cases that involve discrete sequential data points, the GANs of the present disclosure may employ reinforcement learning to create a pseudo embedding for these data points. In reinforcement learning, if a sequence of generated data points 325 is able to fool the discriminator 330, then the reward assigned to the generator 320 would be higher for that sequence of generated data points 325. As previously discussed, the loss function is not very meaningful in guiding the generator 320 as to what are good sequences of data points and what are bad sequences of data points. However, the use of reinforcement learning, with the positive and negative rewards it assigns to the generator 320, enables the generator 320 to model what it means to be a good sequence generator versus a bad sequence generator. The reinforcement learning may comprise a policy gradient method. Policy gradient methods are types of reinforcement learning operations that rely upon optimizing parameterized policies with respect to the expected return (long-term cumulative reward) by gradient descent.

In some example embodiments, during the training of the generator 320, the GAN is configured to generate the candidate sequential data points 325 based on the source sequential data points 315 using a Monte Carlo search operation. In the training of the generative model, the generator 320 uses an aggregation of the batch of rewards 335 when modifying the generative model. In evaluating the rewards 335, the generator 320 determines how well the generative model is doing at each step of the sequential data point generation. For example, if the generator 320 is predicting three career points in total, the generator 320 evaluates the performance at every generated career point in the sequence. Although the discriminator 330 can only assign rewards to a complete sequence of career points, the GAN may simulate the assignment of a reward at each career point by producing a sampling of a plurality of generated sequential data points 325 for the same source sequential data points 315 using a Monte Carlo search method. Using the Monte Carlo search method, given a probability distribution, the generator 320 samples career points, generating N samples (e.g., 10 samples). These N different parallel sequences of data points produced by the generator 320 are fed to the discriminator 330 as input. The discriminator 330 issues a corresponding reward 335 for each one of these N complete sequences of data points. In some example embodiments, the generator 320 averages the rewards 335 out over that batch of Monte Carlo produced sequences of data points. Based on that average, the generator 320 can emulate rewards 335 at every step of the sequence of data points.

In one example, for a single set of source sequential data points 315 Sₚ, N different sequences of data points (A₁→B₁→C₁, . . . , A_{N}→B_{N}→C_{N}) are generated by the generator 320 using the Monte Carlo method. The discriminator 330 issues corresponding rewards R₁ . . . R_{N} for the N generated sequences of data points. The average of the rewards R_{avg} is then calculated by dividing the sum of all of the rewards R₁ . . . R_{N} by the total number of rewards N. In some example embodiments, a threshold value for the average of the rewards R_{avg} for the batch of generated sequential data points 325 for the same source sequential data points 315 is used in the training of the generator to determine whether to continue using the probability distribution of the generative model. In some example embodiments, the reward value is normalized between 0 and 1, and the threshold value is somewhere between 0 and 1. For example, the threshold value may be 0.5, and if the average reward value R_{avg} is below 0.5, then the generator 320 steers away from the probability distribution used in the generative model used to generate the corresponding sequential data points, and if the average reward value R_{avg} is 0.5 or higher, then the generator 320 steers towards the probability distribution used in the generative model used to generate the corresponding sequential data points.

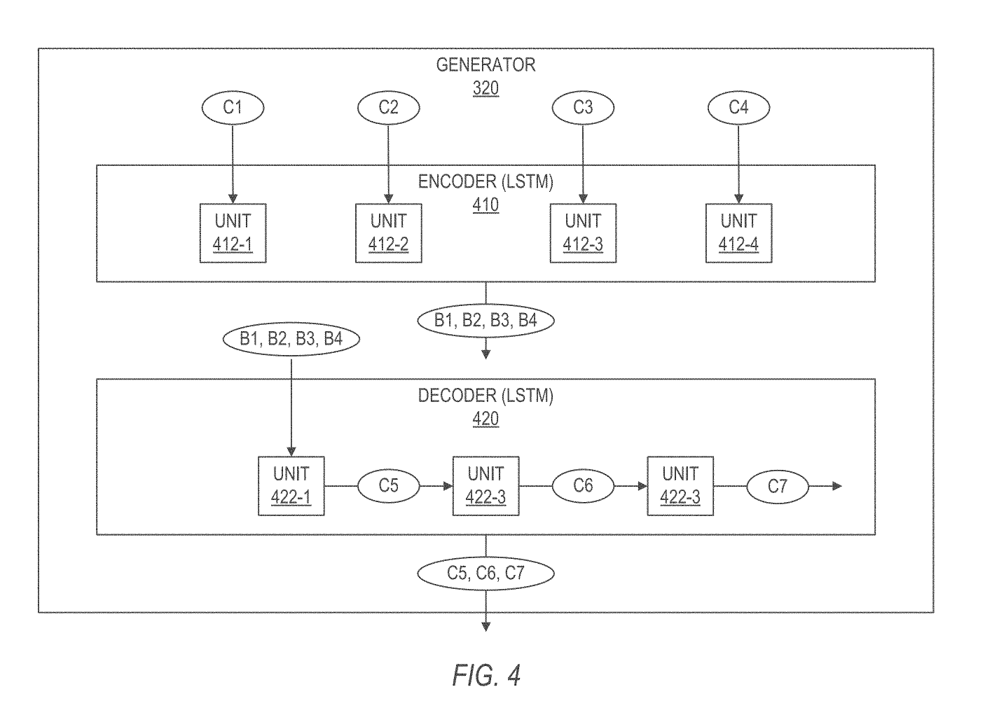

FIG. 4 is a block diagram illustrating the generator 320, in accordance with an example embodiment. In some example embodiments, the generator 320 employs a sequence-to-sequence model based on Long Short-Term Memory (LSTM) cells or units and comprises an encoder 410 and a decoder 420. In some example embodiments, the encoder 410 comprises a plurality of LSTM units 412 (e.g., 412-1, 412-2, 412-3, and 412-4 in FIG. 4) each configured to receive a corresponding source sequential data point C (e.g., C1, C2, C3, and C4 in FIG. 4) of a single sequence of source data points 315 (e.g., a single source career path for a user based on history of employment). The encoder 410 may comprise a plurality of layers of such LSTM units 412. The encoder 410 may perform data processing on the single sequence of source data points 315, converting the source data points 315 that are in raw form (e.g., raw member data from a profile) into numbers or other values (e.g., B1, B2, B3, and B4 in FIG. 4) that can be used by the generative model.

In some example embodiments, the decoder 420 comprises a plurality of LSTM units 422 (e.g., 422-1, 422-2, and 422-3 in FIG. 4), and is configured to receive the converted numbers of values (e.g., B1, B2, B3, and B4 in FIG. 4) from the encoder 410 and generate sequential data points 325 (e.g., C5, C6, and C7 in FIG. 4), which may then be fed as input to the discriminator 330 for training purposes or used in the performance of a function of the online service. The decoder 420 may comprise a plurality of layers of such LSTM units 422. As seen in FIG. 4, the first unit 422-1 of the decoder 420 may receive the sequence of converted source data points 315 (e.g., B1, B2, B3, and B4 in FIG. 4) from the encoder 410, and generate a sequential data point (e.g., C5 in FIG. 4) that is predicted to follow the converted source data points 315. The second unit 422-2 of the decoder 420 may then receive the generated sequential data point 315 (e.g., C5 in FIG. 4) from the first unit 422-1 and generate a sequential data point (e.g., C6 in FIG. 4) that is predicted to follow the first generated sequential data point 315 (e.g., C5 in FIG. 4). The third unit 422-3 of the decoder 420 may then receive the second generated sequential data point 315 (e.g., C6 in FIG. 4) from the second unit 422-2 and generate a sequential data point (e.g., C7 in FIG. 4) that is predicted to follow the second generated sequential data point 315 (e.g., C6 in FIG. 4). The generated sequence of data points 315 (e.g., C5, C6, and C7 in FIG. 4) may then be output by the generator 320 for use in training or in performing a function of the online service. In some example embodiments, the decoder 420 employs an attention mechanism to peek into the encoder to improve the quality of the decoder 420. For example, the decoder 420 may employ a Bahdanau attention mechanism, although other attention mechanisms are also within the scope of the present disclosure.

In some example embodiments, the generator 320 is configured to receive a request associated with a user of an online service. The request may comprise a request to generate one or more sequential data points, such as career points, based on sequential data points stored in a database, such as the database(s) 310, in association with the user, such as profile data of a profile of the user on a social networking service. This request may be triggered in a variety of ways. For example, the request may be triggered in response to, or otherwise based on, the user submitting a request for a predicted career path for the user over a specified number of upcoming years. The request may also be triggered in response to, or otherwise based on, the user submitting a request for a recommendation as to what the next best career move is for the user. The request may also be triggered in response to, or otherwise based on, a detection of the user accessing a page of the online service. The request may also be triggered in response to, or otherwise based on, a detection that a message is going to be transmitted to the user recommending one or more career opportunities (e.g., job openings, potential mentors) for the user. The request may also be triggered in response to, or otherwise based on, another user, such as a recruiter, submitting a request for potential candidates to be considered for a position at an organization.

In some example embodiments, the generator 320 is configured to, in response to the receiving of the request, retrieve a plurality of source sequential data points 315 of the user, such as from a profile of the user stored on the database(s) 310 of the online service. In some example embodiments, the source plurality of sequential data points comprises at least one attribute for each one of a plurality of sequential career points of the user. Such attributes may include, but are not limited to, any combination of one or more of a company or organization with which the user was previously or is currently employed (e.g., “Acme Inc.”), a job title of the user with a company or organization with which the user was previously or is currently employed (e.g., “Software Engineer”), a size of a company or organization with which the user was previously or is currently employed (e.g., “10,000+ employees”), skills of the user (e.g., “Machine Learning”), education of the user (e.g., university attended, courses, major), and an industry of a company or organization with which the user was previously or is currently employed (e.g., “Computer Software”).

In some example embodiments, the generator 320 is configured to generate at least one predicted sequential data point 325 for the user based on the plurality of source sequential data points 315 using the generative model. The generated predicted data point(s) may comprise at least one attribute for a predicted career point for the user. Such attributes may include, but are not limited to, any combination of one or more of a company or organization with which the user was previously or is currently employed (e.g., “Acme Inc”), a job title of the user with a company or organization with which the user was previously or is currently employed (e.g., “Software Engineer”), a size of a company or organization with which the user was previously or is currently employed (e.g., “10,000+ employees”), skills of the user (e.g., “Machine Learning”), education of the user (e.g., university attended, courses, major), and an industry of a company or organization with which the user was previously or is currently employed (e.g., “Computer Software”).

In some example embodiments, the generator 320, or some other component of the data prediction system 216, is configured to perform a function of the online service using the generated predicted data point(s). In some example embodiments, the performing the function comprises causing the generated at least one predicted career point to be displayed on a computing device in association with the request.

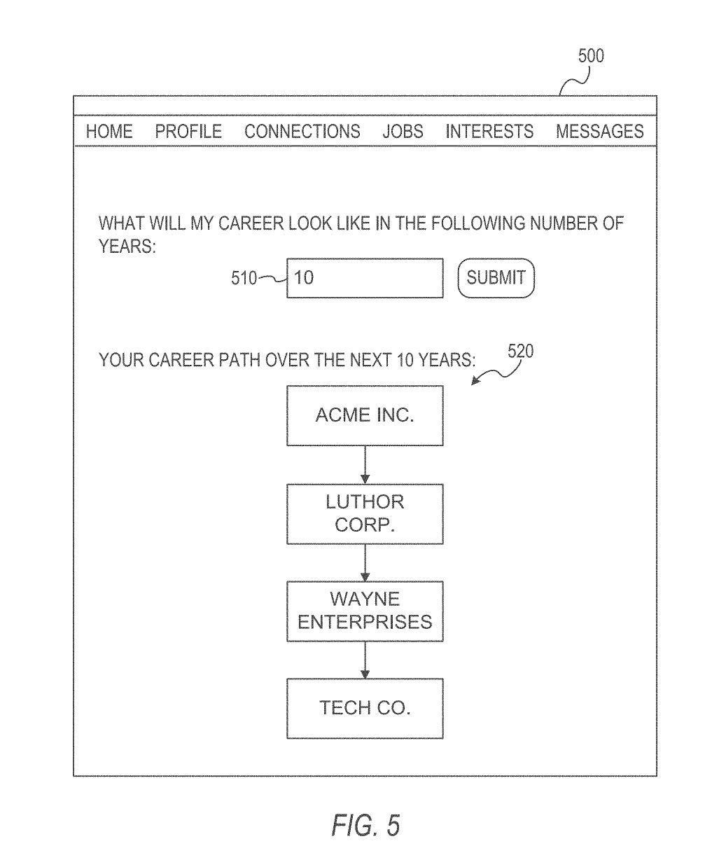

FIG. 5 illustrates a GUI 500 in which generated predicted data points are used in a function of the online service, in accordance with an example embodiment. In FIG. 5, a user has submitted a request for a prediction of what the user's career will look like over a specified duration of time (e.g., number of years). In some example embodiments, the user may specify the duration of time via a user interface element 510, such as a text field. In response to, or otherwise based on, the request submitted by the user, generated predicted data points 520, such as career points forming a career path (e.g., ACME INC.→LUTHOR CORP.→WAYNE ENTERPRISES→TECH CO.) are displayed within the GUI 500 in association with the request.

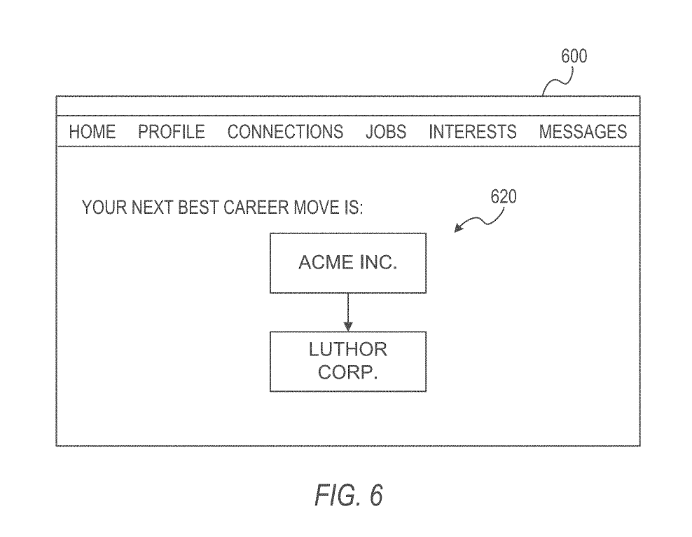

FIG. 6 illustrates another GUI 600 in which generated predicted data points are used in a function of the online service, in accordance with an example embodiment. In FIG. 6, a user has submitted a request for a prediction of the user's next best career move. In response to, or otherwise based on, the request submitted by the user, a prediction 620 including a move from a current career point (e.g., ACME INC.) to a generated predicted career point (e.g., LUTHOR CORP.) is displayed within the GUI 600 in association with the request.

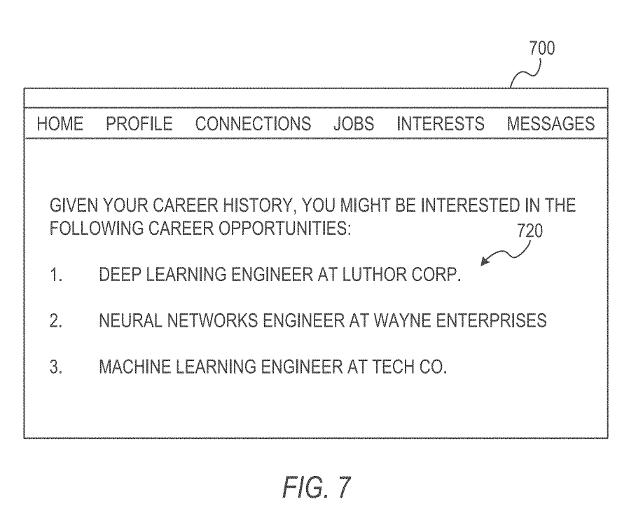

FIG. 7 illustrates yet another GUI 700 in which generated predicted data points are used in a function of the online service, in accordance with an example embodiment. In FIG. 7, the GUI 700 displays recommended career opportunities in the form of job openings 720. These job openings 720 include generated predicted career points (e.g., DEEP LEARNING ENGINEER AT LUTHOR CORP.). In some example embodiments, each displayed job opening 720 comprises a selectable link configured to navigate the user to page where the user can apply for the job opening 720 in response to its selection.

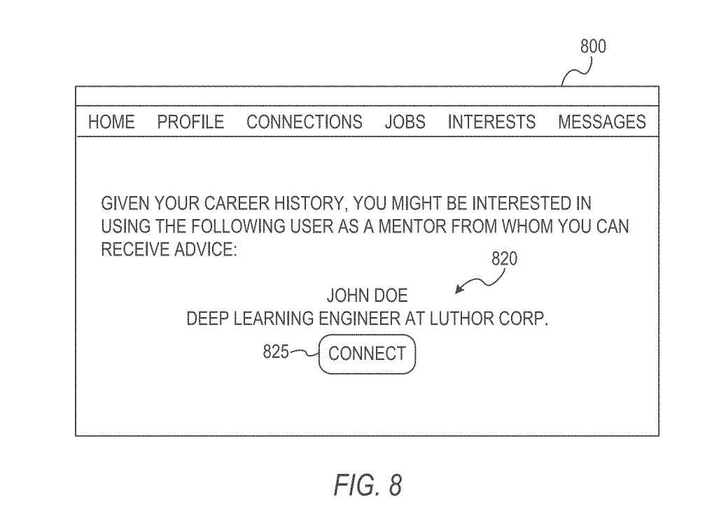

FIG. 8 illustrates yet another GUI 800 in which generated predicted data points are used in a function of the online service, in accordance with an example embodiment. In FIG. 8, the GUI 800 displays recommended career opportunities in the form of one or more recommended mentors 820 (e.g., JOHN DOE) based on one or more generated career points. In some example embodiments, the data prediction system 216 may generate one or more predicted career points for the user based on the user's current history of employment or other career data points, then find one or more other users that have the closest or shortest distance to the predicted career point(s) of the user, and then display the other user(s) as a recommended mentor for the user. In some example embodiments, a selectable user interface element 825 is configured to establish or request a connection between the user and the corresponding other user in response to the selectable user interface element 825 being selected.

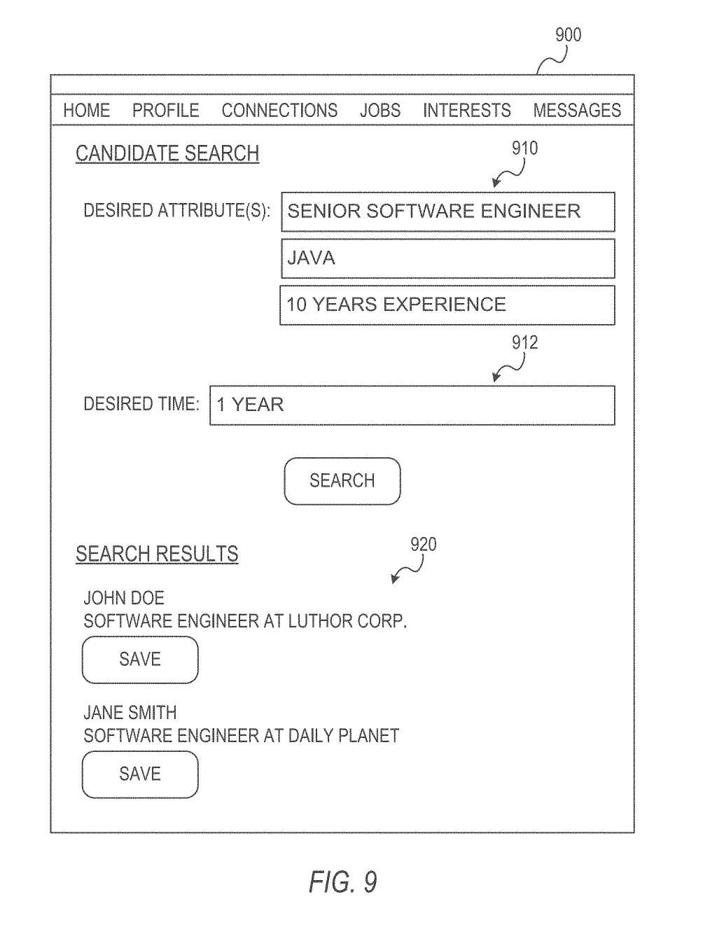

FIG. 9 illustrates yet another GUI 900 in which generated predicted data points are used in a function of the online service, in accordance with an example embodiment. In FIG. 9, another user, such as a recruiter, has submitted a request for potential candidates to be considered for a position at an organization. In some example embodiments, the recruiter may specify desired attributes (e.g., job titles in employment history, skills, experience level) via user interface elements 910 (e.g., text fields), and may specify a time at which a candidate will be desired for the position at the organization (e.g., in 1 year) via a user interface element 912. In some example embodiments, in response to, or otherwise based on, the request submitted by the other user, the data prediction system 216 identities one or more users that are predicted to satisfy the request of the recruiter based on a comparison of the desired attributes and desired time specified as part of the request with predicted career points generated for users by the generator 320. The results 920 of this recruiter search for candidates that satisfy the recruiter's request are displayed within the GUI 900 in association with the request.

In some example embodiments, a corresponding selectable user interface element (e.g., a “SAVE” button in FIG. 9) is displayed in association with each one of the results 920, and is configured to save an indication of the corresponding result in the database(s) 310 for subsequent use in reminding the recruiter to contact the corresponding user identified in the results 920 at or just prior to the desired time. For example, in FIG. 9, if the recruiter selects to save JANE DOE, then the data prediction system 216 may save an indication of this selection, and then prompt the recruiter (e.g., via an e-mail message or a notification on a page of the online service) to contact JANE DOE. This prompting may be performed in response to, or otherwise based on, a detection of the current time satisfying a specified threshold with respect to the specified desired time of the request. For example, in response to detecting that the current time is within one month of the desired time, the data prediction system 216 may prompt the recruiter to contact the corresponding user regarding the position at the organization.

In some example embodiments, a function of the online service comprises performing a search based on a search query submitted by a user to a search engine of the online service. In some example embodiments, the performing of the search comprises using the generated predicted career point(s) in a query expansion operation for the search query to expand the search query to include the generated predicted career point(s).

It is contemplated that the data prediction system 216 use the predicted data point(s) generated by the generator 320 in the performance of other functions of the online service other than those disclosed herein.

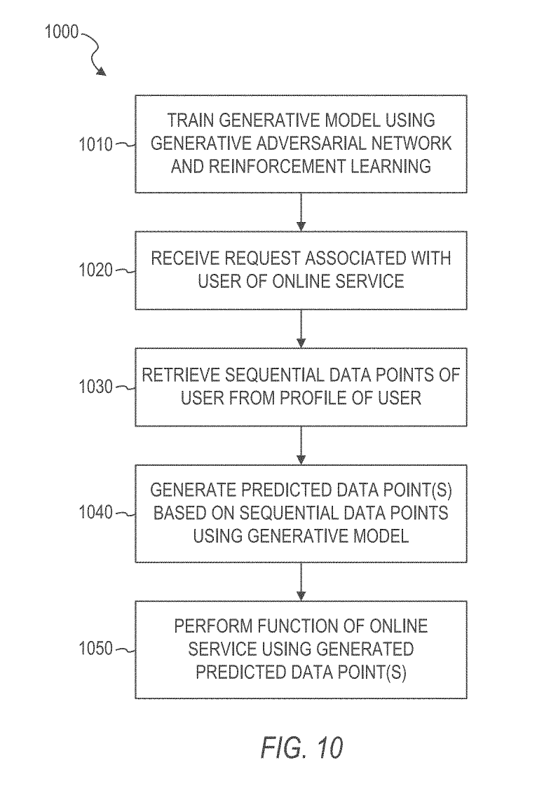

FIG. 10 is a flowchart illustrating a method 1000 of predicting sequential data using a generative adversarial network, in accordance with an example embodiment. The method 1000 can be performed by processing logic that can comprise hardware (e.g., circuitry, dedicated logic, programmable logic, microcode, etc.), software (e.g., instructions run on a processing device), or a combination thereof. In one implementation, the method 1000 is performed by the data prediction system 216 of FIGS. 2-3, or any combination of one or more of its modules, as described above.

At operation 1010, the data prediction system 216 trains a generative model using a generative adversarial network (GAN). In some example embodiments, the GAN comprises a generative neural network and a discriminative neural network. In some example embodiments, the GAN is configured to generate candidate sequential data points based on source sequential data points retrieved from profiles stored on a database of an online service. In some example embodiments, the discriminative neural network comprises a two-class classification convolutional neural network (CNN) configured to discriminate between the generated candidate sequential data points and true sequential data points retrieved from the profiles stored on the database of the online service. In some example embodiments, the training comprises using reinforcement learning to train the generative model, and the discriminative neural network is configured to issue a reward to the GAN based on a determination that the GAN fooled the discriminative neural network into identifying the candidate sequential data points as being true sequential data points retrieved from the profiles stored on the database of the online service. In some example embodiments, the GAN is configured to generate the candidate sequential data points based on the source sequential data points using a Monte Carlo method.

At operation 1020, the data prediction system 216 receives a request associated with a user of an online service. In some example embodiments, the request comprises a request to generate one or more sequential data points, such as career points, based on sequential data points stored in a database in association with the user, such as profile data of a profile of the user on a social networking service.

At operation 1030, in response to the receiving of the request, the data prediction system 216 retrieves a plurality of sequential data points of the user from the profile of the user stored on the database of the online service. In some example embodiments, the plurality of sequential data points comprises at least one attribute for each one of a plurality of sequential career points of the user. In some example embodiments, the attribute(s) for each one of the plurality of sequential career points comprises at least one company name, and the at least one attribute for the predicted career point comprises at least one other company name. In some example embodiments, the attribute(s) for each one of the plurality of sequential career points comprises at least one company name and one or more of a job title, a company size, and an industry, and the at least one attribute for the predicted career point comprises at least one other company name and one or more of another job title, another company size, and another industry.

At operation 1040, the data prediction system 216 generates at least one predicted data point for the user based on the plurality of sequential data points using a generative model. In some example embodiments, the generated predicted data point(s) comprise at least one attribute for a predicted career point for the user. In some example embodiments, the generated predicted data point(s) comprise a sequence of predicted data points, with each predicted data point in the sequence comprising the attribute(s) for the corresponding predicted career point.

At operation 1050, the data prediction system 216 performs a function of the online service using the generated at least one predicted data point In some example embodiments, the performing the function comprises causing the generated at least one predicted career point to be displayed on a computing device in association with the request. In some example embodiments, the request comprises a search query submitted to a search engine of the online service, and the performing the function comprises using the generated predicted career point(s) in a query expansion operation for the search query to expand the search query to include the generated predicted career point(s).

It is contemplated that any of the other features described within the present disclosure can be incorporated into the method 1000.

### Example Mobile Device

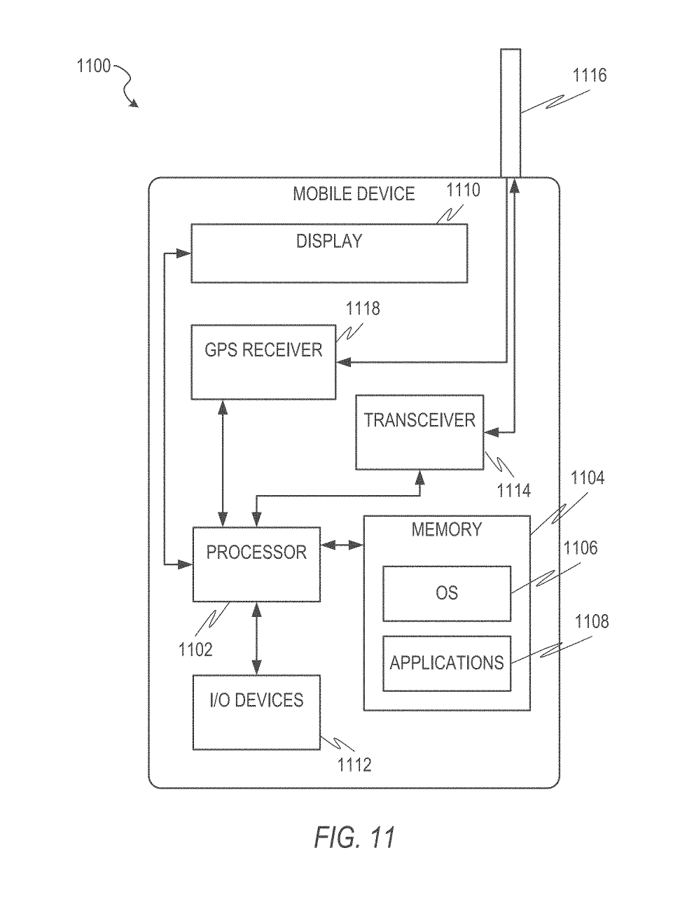

FIG. 11 is a block diagram illustrating a mobile device 1100, according to an example embodiment. The mobile device 1100 can include a processor 1102. The processor 1102 can be any of a variety of different types of commercially available processors suitable for mobile devices 1100 (for example, an XScale architecture microprocessor, a Microprocessor without Interlocked Pipeline Stages (MIPS) architecture processor, or another type of processor) A memory 1104, such as a random access memory (RAM), a Flash memory, or other type of memory, is typically accessible to the processor 1102. The memory 1104 can be adapted to store an operating system (OS) 1106, as well as application programs 1108, such as a mobile location-enabled application that can provide location-based services (LBSs) to a user. The processor 1102 can be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 can be coupled to a transceiver 1114 that interfaces with an antenna 1116. Hie transceiver 1114 can be configured to both transmit and receive cellular network signals, wireless data signals, or other types of signals via the antenna 1116, depending on the nature of the mobile device 1100. Further, in some configurations, a GPS receiver 1118 can also make use of the antenna 1116 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs))

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

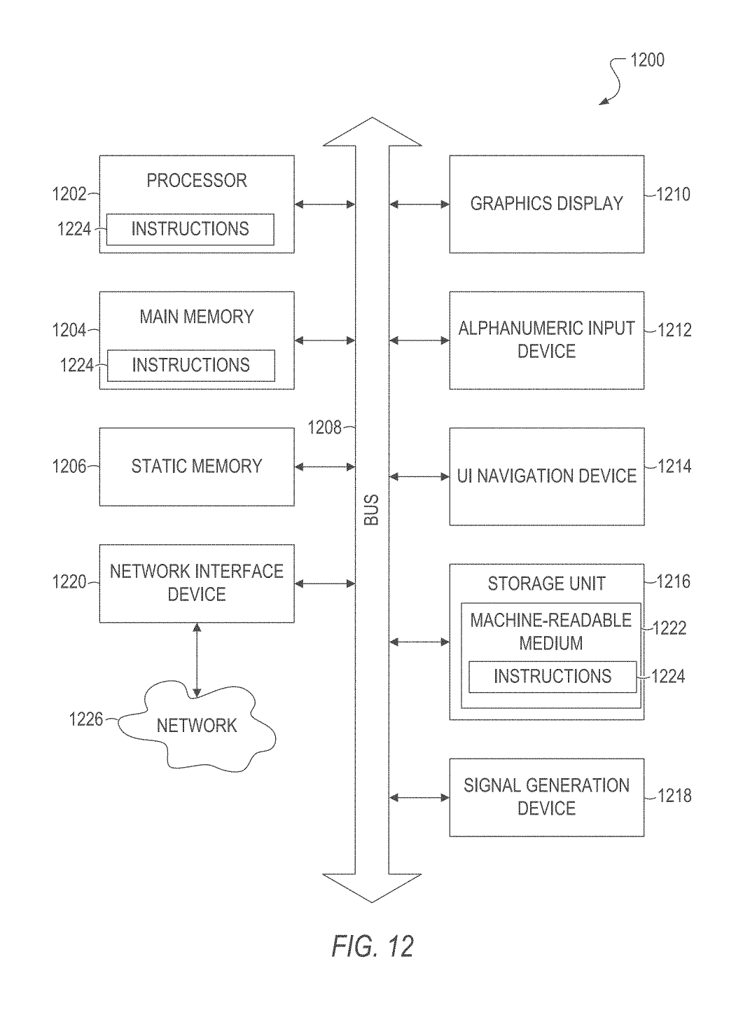

FIG. 12 is a block diagram of an example computer system 1200 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a graphics display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation device 1214 (e.g., a mouse), a storage unit 1216, a signal generation device 1218 (e.g., a speaker) and a network interface device 1220.

### Machine-Readable Medium

The storage unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding or carrying instructions (e.g., instructions 1224) for execution by the machine and that cause lire machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices, magnetic disks such as internal hard disks and removable disks, magneto-optical disks; and CD-ROM and DVD-ROM disks

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
receiving, by a computer system having a memory and at least one hardware processor, a request associated with a user of an online service;
in response to the receiving of the request, retrieving, by the computer system, a first plurality of sequential data points of the user from a profile of the user stored on a database of the online service, the first plurality of sequential data points comprising at least one attribute for each one of a plurality of sequential career points of the user;
generating, by the computer system, at least one predicted data point for the user based on the first plurality of sequential data points using a generative model, the generated at least one predicted data point comprising at least one attribute for a predicted career point for the user; and
performing, by the computer system, a function of the online service using the generated at least one predicted data point.

2. The computer-implemented method of claim 1, further comprising training the generative model using a generative adversarial network (GAN), the GAN comprising a generative neural network and a discriminative neural network, the GAN configured to generate candidate sequential data points based on source sequential data points retrieved from profiles stored on the database of the online service, the discriminative neural network comprising a two-class classification convolutional neural network (CNN) configured to discriminate between the generated candidate sequential data points and true sequential data points retrieved from the profiles stored on the database of the online service.

3. The computer-implemented method of claim 2, wherein the training comprises using reinforcement learning to train the generative model, the discriminative neural network being further configured to issue a reward to the GAN based on a determination that the GAN fooled the discriminative neural network into identifying the candidate sequential data points as being true sequential data points retrieved from the profiles stored on the database of the online service.

4. The computer-implemented method of claim 2, wherein the GAN is configured to generate the candidate sequential data points based on the source sequential data points using a Monte Carlo method.

5. The computer-implemented method of claim 1, wherein the at least one attribute for each one of the plurality of sequential career points comprises at least one company name, and the at least one attribute for the predicted career point comprises at least one other company name.

6. The computer-implemented method of claim 1, wherein:
the at least one attribute for each one of the plurality of sequential career points comprises at least one company name and one or more of a job title, a company size, and an industry; and
the at least one attribute for the predicted career point comprises at least one other company name and one or more of another job title, another company size, and another industry.

7. The computer-implemented method of claim 1, wherein the generated at least one predicted data point comprises a sequence of predicted data points, each predicted data point in the sequence comprising the at least one attribute for the corresponding predicted career point.

8. The computer-implemented method of claim 1, wherein the performing the function comprises causing the generated at least one predicted career point to be displayed on a computing device in association with the request.

9. The computer-implemented method of claim 1, wherein the request comprises a search query submitted to a search engine of the online service, and the performing the function comprises using the generated at least one predicted career point in a query expansion operation for the search query to expand the search query to include the generated at least one predicted career point.

10. A system comprising:
at least one hardware processor; and
a non-transitory machine-readable medium embodying a set of instructions that, when executed by the at least one hardware processor, cause the at least one processor to perform operations, the operations comprising:
receiving a request associated with a user of an online service;
based on the receiving of the request, retrieving a first plurality of sequential data points of the user from a profile of the user stored on a database of the online service, the first plurality of sequential data points comprising at least one attribute for each one of a plurality of sequential career points of the user;
generating at least one predicted data point for the user based on the first plurality of sequential data points using a generative model, the generated at least one predicted data point comprising at least one attribute for a predicted career point for the user; and
performing a function of the online service using the generated at least one predicted data point.

11. The system of claim 10, wherein the operations further comprise training the generative model using a generative adversarial network (GAN), the GAN comprising a generative neural network and a discriminative neural network, the GAN configured to generate candidate sequential data points based on source sequential data points retrieved from profiles stored on the database of the online service, the discriminative neural network comprising a two-class classification convolutional neural network (CNN) configured to discriminate between the generated candidate sequential data points and true sequential data points retrieved from the profiles stored on the database of the online service.

12. The system of claim 11, wherein the training comprises using reinforcement learning to train the generative model, the discriminative neural network being further configured to issue a reward to the GAN based on a determination that the GAN fooled the discriminative neural network into identifying the candidate sequential data points as being true sequential data points retrieved from the profiles stored on the database of the online service.

13. The system of claim 11, wherein the GAN is configured to generate the candidate sequential data points based on the source sequential data points using a Monte Carlo method.

14. The system of claim 10, wherein the at least one attribute for each one of the plurality of sequential career points comprises at least one company name, and the at least one attribute for the predicted career point comprises at least one other company name.

15. The system of claim 10, wherein:
the at least one attribute for each one of the plurality of sequential career points comprises at least one company name and one or more of a job title, a company size, and an industry; and
the at least one attribute for the predicted career point comprises at least one other company name and one or more of another job title, another company size, and another industry.

16. The system of claim 10, wherein the generated at least one predicted data point comprises a sequence of predicted data points, each predicted data point in the sequence comprising the at least one attribute for the corresponding predicted career point.

17. The system of claim 10, wherein the performing the function comprises causing the generated at least one predicted career point to be displayed on a computing device in association with the request.

18. The system of claim 10, wherein the request comprises a search query submitted to a search engine of the online service, and the performing the function comprises using the generated at least one predicted career point in a query expansion operation for the search query to expand the search query to include the generated at least one predicted career point.

19. A non-transitory machine-readable medium embodying a set of instructions that, when executed by at least one hardware processor, cause the processor to perform operations, the operations comprising:
receiving a request associated with a user of an online service;
based on the receiving of the request, retrieving a first plurality of sequential data points of the user from a profile of the user stored on a database of the online service, the first plurality of sequential data points comprising at least one attribute for each one of a plurality of sequential career points of the user;
generating at least one predicted data point for the user based on the first plurality of sequential data points using a generative model, the generated at least one predicted data point comprising at least one attribute for a predicted career point for the user, and
performing a function of the online service using the generated at least one predicted data point.

20. The non-transitory machine-readable medium of claim 19, further comprising training the generative model using a generative adversarial network (GAN), the GAN comprising a generative neural network and a discriminative neural network, the GAN configured to generate candidate sequential data points based on source sequential data points retrieved from profiles stored on the database of the online service, the discriminative neural network comprising a two-class classification convolutional neural network (CNN) configured to discriminate between the generated candidate sequential data points and true sequential data points retrieved from the profiles stored on the database of the online service.
